(19) United States
(12) Patent Application Publication
(10) Pub. No.: US 2025/0368106 A1
(43) Pub. Date: Dec. 4, 2025

(54) PADDING SYSTEM WITH ROTATION-LOCKING FASTENING DEVICE

(71) Applicants: FAURECIA Sièges d'Automobile, NANTERRE (FR); Indorama Ventures Mobility Obernburg GmbH, Obernburg (DE)

(72) Inventors: Mathieu CLUET, ETAMPES (FR); Benoît GAZANIOL, ARPAJON (FR); Mathieu BOQUET, VERRIERES LE BUISSON (FR)

(21) Appl. No.: 19/219,414

(22) Filed: May 27, 2025

(30) Foreign Application Priority Data
May 28, 2024 (FR) 2405487

(51) Int. Cl. B60N 2/58

(52) U.S. Cl. CPC B60N 2/5825

(57) ABSTRACT

This disclosure relates to a padding system comprising: a padding comprising a groove on a surface of the padding intended to receive an occupant, a hole extending in depth of a bottom wall of the groove, a removable fastening device, integral with the padding, configured to provide the fastening of a cover to the padding, the fastening device comprising a first clip-on fastening part and a second attachment part extending into the hole comprising at least one stop wall configured to come into contact against at least one shoulder during a tensile force generated by the cover to prevent extraction of the fastening device.

### PRIORITY CLAIM

This application claims priority to French Patent Application No. FR2405487, filed May 28, 2024, which is expressly incorporated by reference herein.

### BACKGROUND

This disclosure relates to the field of fastening devices configured to secure a cover to a padding. This disclosure also relates to a padding and a fastening device attached to the padding configured to ensure the maintenance of a cover on the padding.

### SUMMARY

According to the present disclosure, a padding system is proposed, comprising:
padding comprising a groove on a surface of the padding intended to receive an occupant
a removable fastening device, integral with the padding, configured to provide the fastening of a cover to the padding, the fastening device comprising:
a first fastening part, in particular a clip-on part, comprising in particular a deformable elastic portion, configured to allow the fastening of the cover, the first fastening part, held projecting in the groove, comprising a base,
a second attachment part comprising at least a first locking wing and a second locking wing, extending on either side of the base, arranged on either side of the first fastening part,

and in which the fastening device is configured to be fastened to the padding by:
inserting the fastening device into the padding, in a first insertion position in order to position the first fixing part within the groove, and the first locking wing and the second locking wing within the groove, or inserted into a first hole and a second hole deep in a bottom wall of the groove,
locking the fastening device to the padding by rotating the fastening device around an axis of rotation, from the first insertion position to a second locking position so as to cause the first locking wing and the second locking wing to penetrate, respectively, into a first housing forming a stop wall engaging with a terminal end of the first locking wing, and a second housing forming a stop wall engaging with a terminal end of the second locking wing, the engagements between the first locking wing and the second locking wing and the stop walls being configured, during a tensile force generated by the cap, to prevent extraction of the fastening device.

The features set out in the following paragraphs may, optionally, be implemented independently of one another or in combination with one another:

According to one embodiment, the first locking wing and the second locking wing of the fastening device are symmetrical with respect to the axis of rotation, the axis of rotation passing through the first fixing part, or even the fastening device is symmetrical with respect to the axis of rotation.

According to one embodiment, the fastening device comprises a stud projecting below the base, the stud coaxial with the axis of rotation, and the bottom of the groove of the padding comprises a housing complementary to the stud, the engagement between the stud and the complementary housing providing centering and guidance of the fastening device relative to the padding during rotation of the fastening device from the first insertion position to the second locking position.

Generally, the axis of rotation is transverse to the bottom of the groove, for example, perpendicular to the bottom of the groove.

According to one embodiment, the first fixing part is a clipping part comprising a first element and a second element, extending parallel to each other, the first element and the second element projecting from the base forming between them a hooking groove for elastic engagement of a hooking rib of the cover, the hooking groove preferably aligned with a longitudinal axis of the groove of the padding in the second locking position.

According to one embodiment, a locking system is configured to provide locking of the rotation of the fastening device relative to the padding in the second locking position, and comprising at least one orifice of the first locking wing and/or of the second locking wing such as a first orifice of the first wing and a second orifice of the second wing, and at least one protruding lug of the stop wall of the first housing and/or of the second housing, such as a first lug of the stop wall of the first housing and a second lug of the stop wall of the second housing

and in which the locking system is configured to provide locking in rotation of the fastening device relative to the padding by engagement of the lug in the at least one orifice in the second locking position.

According to one embodiment, the first locking wing and the second locking wing extend as an extension of the base of the first fixing part, in particular of the base, the first locking wing and the second wing extending along a plane of the base, perpendicular to the axis of rotation up to the terminal ends of the first locking wing and the second wing, configured to penetrate the first housing and the second housing.

According to one embodiment, the first wing and the second locking wing comprise:
first length sections extending diametrically opposite relative to the base, away from the axis of rotation, the first length sections following a first direction D1,
the terminal ends, comprising a first terminal end and a second terminal end extending inclined, relative to the first direction D1, in opposite directions, in particular the first terminal end and the second end along a plane perpendicular to the axis of rotation

and in which the fastening device is configured to allow rotation from the first insertion position to the second locking position according to an angular travel of less than 45°, for example less than 30°.

According to one embodiment, the first locking wing and the second locking wing extending as an extension of a base of the first fixing part, the first locking wing and the second locking wing respectively comprise:
first length portions extending diametrically opposite relative to the base along a plane of the base,
second length portions, extending as an extension of the first length portions, at least along a component along the direction of the axis of rotation, moving away from the first fixing part from the first length portions
the terminal ends comprising a first terminal end and a second terminal end extending outwardly along a second plane, perpendicular to the axis of rotation, the second plane spaced from the plane of the base along the direction of the axis of rotation.

According to one embodiment, the fastening device, including the first fastening part, in particular the clipping part, and the second attachment part, is a single-piece plastic component.

According to one embodiment, the padding comprises a 3D tangle of continuous thermoplastic fibers arranged irregularly forming loops welded together, the groove, the first housing and the second housing being formed in the 3D tangle of fibers, in particular at the densified zone of the tangle.

According to one embodiment, the material of the padding and the material of the fastening device are a thermoplastic polymer whose main chain repeating unit comprises the ester function and optionally the ether function.

According to one embodiment, in the second locking position, the two abutment walls of the first and second housings, bearing respectively with the first terminal end and the second terminal end, are two supports extending transversely on either side of the groove.

According to one embodiment, the first housing and the second housing are formed by two recesses opening from a surface of the padding opposite the surface of the padding carrying the groove, the first housing and the second housing being respectively in communication with the groove directly according to a first possibility, or indirectly according to a second possibility by a first hole in the bottom of the groove, connecting the first housing to the groove, and by a second hole in the bottom of the groove connecting the second housing to the groove, the first housing in communication with the first hole by a first lateral passage, and the second housing in communication with the second hole by a second lateral passage.

The fastening device is oriented so that the direction passing through the terminal ends of the first and second wings is substantially aligned with a longitudinal axis of the groove in the first insertion position.

The locking of the fastening device to the padding is obtained by rotation of the fastening device about the transverse rotation axis at the bottom of the groove, from the first insertion position to a second locking position, rotation during which the first locking wing and the second locking wing respectively pass through the first passage and the second lateral passage, to be inserted respectively into the first housing and the second housing according to the second possibility.

According to an embodiment in the second locking position, the fastening device is locked in the direction opposite to the extraction direction by contact of the base of the fastening device with the bottom of the groove or the bottom of the first hole or second hole.

This disclosure also relates to a vehicle seat assembly comprising a padding system according to this disclosure, in the locking position of the fastening device and a cover covering all or part of the padding, and fixed to the padding by a fixing element, in particular a clip-on element, engaging, for example in an elastic interlocking manner with the first fixing part, of the fastening device.

This disclosure also relates to a method for manufacturing a cushioning system according to this disclosure comprising:
/A/ Obtaining a cushioning by extruding a 3D tangle of continuous thermoplastic fibers, arranged irregularly, forming loops welded together,
/B/ Shaping the 3D tangle by thermoforming in order to obtain the groove and a first housing and a second housing in communication with the groove
/C/ Providing a fastening device comprising:
a first fastening part, in particular a clip-on part, comprising in particular a deformable elastic portion, configured to allow the fastening of the cap,
a second fastening part comprising a first locking wing and a second locking wing, arranged on either side of the first fastening part,
/D/ inserting the fastening device into the cushioning, in a first insertion position in order to position the first fastening part within the groove, and the first locking wing and the second locking wing within the groove, or inserted into a first hole and a second hole deep in a groove bottom wall,
/E/ locking the fastening device to the padding by rotating the fastening device around an axis of rotation from the first insertion position to a second locking position so as to cause the first locking wing and the second locking wing to penetrate, respectively, into the first locking housing which forms a stop wall engaging with the first locking wing, and the second housing forming a stop wall engaging with the second locking wing, the engagements between the first locking wing and the second locking wing and the stop walls being configured, during a tensile force generated by the cap, to prevent extraction of the fastening device.

This disclosure also relates to a method for recycling a vehicle seat assembly according to this disclosure, in which the material of the padding and the fastening device is a thermoplastic polymer whose main chain repeating unit comprises the ester function and optionally the ether function, comprising:
optionally, a separation of the cover from the padding system,
grinding of the padding and the fastening device attached to the padding, with a view to producing granules
using the granules for the manufacture of a plastic product based on a thermoplastic polymer whose main chain repeating unit comprises the ester function and optionally the ether function, in particular by molding or extrusion.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a view of a padding system, according to a first embodiment, comprising padding and a fastening device comprising a first fixing part in a clipping part projecting from a bottom wall of a groove, and a second attachment part engaging with a first housing and a second housing of the padding to provide the locking of the fastening device.

FIG. 2 is a view of the padding system along a sectional plane perpendicular to the axis of the groove of the padding, illustrating the fastening device of which the first fixing part, in particular the clipping part, forms an elastic groove within the groove, the second attachment part comprising a first locking wing and a second locking wing, extending on either side of a base of the elastic groove, the first locking wing and the second locking wing extending transversely to the groove of the padding, respectively in a first housing and in a second housing of the padding, arranged on either side of the groove, the first locking wing and the second locking wing configured to bear respectively against a stop wall of the first housing and against a stop wall of the second housing to oppose, during a tensile force generated by the cap, an extraction of the fastening device, a first lug of the stop wall of the first housing engaging with a first orifice of the first locking wing, and a second lug of the stop wall engaging with a second orifice of the second locking wing, the sectional view, further illustrating a stud, lower projection of the base of the elastic groove, coaxial with an axis of rotation of the fastening device, the stud penetrating into a complementary housing deep in the bottom of the groove.

FIG. 3 is a detailed perspective view of the fastening device which may be a single-piece plastic component, the first locking wing, and the second locking wing extending in a direction perpendicular to the axis in a plane of the base.

FIG. 4 is a bottom view of the fastening device, illustrating the protruding stud under the base, the stud configured to provide centering and guidance during rotation of the fastening device.

FIG. 5 is a bottom view of the padding from the side opposite the surface of the padding comprising the groove, illustrating the first housing and the second housing, obtained by thermoforming.

FIG. 6 is a view of the padding along a section plane, perpendicular to the axis of the groove (the fastening device not shown).

FIG. 7 is from left to right, a succession of images of the padding system, seen from above, illustrating the insertion of the fastening device, the first wing and the second wing oriented in the direction of the groove.

FIG. 8 is from left to right, a succession of images of the padding system, seen from above, illustrating, from the first position of the fastening device (on the left), in the groove of the padding, the locking of the fastening device, obtained by rotating the fastening device a quarter turn (90°) around the axis of rotation, and up to the second locking position illustrated on the right.

FIG. 9 is a succession of images of the padding system, seen from below, illustrating the rotation of the fastening device to the second locking position.

FIG. 10 is:
on the left, a view of a second embodiment of the cushioning system, the first wing and the second locking wing comprising first length sections extending diametrically opposite relative to the base, away from the axis of rotation, the first length sections following a first direction D1, and terminal ends, comprising a first terminal end and a second terminal end extending inclined relative to the first direction D1, in opposite directions, the first locking wing and the second locking wing with their inclined terminal end forming an S shape when seen along the axis of rotation, such a fastening device being notable in that it is configured to allow rotation from the first insertion position to the second locking position according to an angular travel a much less than a quarter turn, for example less than 45°, for example less than 30° around the axis of rotation,
on the right, a view illustrating the angular travel of the fastening device to pass from the first position insertion to the second locking position.

FIG. 11 is a view of a third embodiment of the padding system, FIG. 11 illustrating the fastening device, the first locking wing and the second locking wing respectively comprise
first length portions extending diametrically opposite relative to the base along a plane of the base,
second length portions, extending as an extension of the first length portions, at least along a component along the direction of the axis of rotation, moving away from the first fixing part from the first length portions
the terminal ends comprising a first terminal end and a second terminal end extending outwardly along a second plane, perpendicular to the axis of rotation, the second plane spaced from the plane of the base along the direction of the axis of rotation.

FIG. 12 is a top view of the fastening device according to FIG. 11, seen along the axis of rotation, the first wing and the second locking wing comprising first length sections extending diametrically opposite relative to the base, away from the axis of rotation, the first length sections following a first direction D1, and terminal ends, comprising a first terminal end and a second terminal end extending inclined relative to the first direction D1, in opposite directions, the first wing and the second wing, with their inclined terminal end forming an S shape.

FIG. 13 is a view of a succession of three images, illustrating from left to right:
a view of the padding from the groove side, illustrating a first hole and a second hole at the bottom of the groove of the padding, the first hole and the second hole intended to receive respectively the first locking wing (including the second length portion and the first terminal end) and the second locking wing (including the second length portion),
a bottom view, illustrating the formation of the first housing in communication with the first hole, and of the second housing in communication with the second hole, the first housing and the second housing offset on either side of the groove, transversely to the groove,
a side view of the groove.

FIG. 14 is a top view of the cushioning system, illustrating three images, with from left to right:
a first view illustrating the insertion of the fastening device so as to position the first fastening part in the groove, and simultaneously, the first terminal end and the second length portion of the first locking wing in the first hole; and the second terminal end and the second length portion of the second locking wing in the second hole,
a second view illustrating the fastening device in the first insertion position,
a third view illustrating the rotation providing the passage of the fastening device from the first insertion position to the second locking position for which the first terminal end penetrates the first housing and the second terminal end penetrates the second housing, the cooperation of the terminal ends with stop walls of the housings preventing the extraction of the fastening device.

FIG. 15 is a view of a method of manufacturing padding by extrusion of thermoplastic fibers, including accumulating the fibers to obtain a tangle of continuous fibers arranged irregularly forming loops welded together, and solidifying the tangle of continuous fibers in a cooling liquid.

### DETAILED DESCRIPTION

This disclosure relates to a padding system 1 comprising padding 2 and a removable fastening device 3, the fastening device secured to the padding being configured to allow the fastening of a cover covering the padding 2, preferably in tension on the padding.

The padding may comprise a 3D tangle of continuous thermoplastic fibers arranged irregularly forming loops welded together, and on which the fastening device 3 is attached. Generally, the fibers of the 3D tangle, for example, polyester-based, may be hollow fibers and/or solid fibers. The fibers may have a diameter of between 0.2 mm and 2 mm, preferably between 0.3 mm and 1.5 mm. By “continuous” in “continuous fibers” is meant the fact that the fibers are of a length much greater than the diameter of the fibers, and due to the manufacturing process, which is described below, for example, at least by a ratio of 100, or even 500, or even 1000.

The 3D entanglement of continuous fibers may have an apparent density of between 20 kg/m3 and 70 kg/m3, in particular between 45 kg/m3 and 60 kg/m3, preferably between 35 and 70 kg/m3.

For example, the composition of the fibers, or even of the padding, comprises:
95% to 99% by weight of a first polymer from the polyester family such as PBT (Polybutylene terephthalate),
1% to 5% by weight of a second polymer from the polyester family such as PTT (Polytrimethylene terephthalate) or another polyester.

Very often, and in particular as understood from the extrusion manufacturing process which will be described below, the fibers, for example, extend from a first end on a first edge of the 3D entanglement and to a second end on a second edge of the 3D entanglement, opposite the first edge.

Preferably, the voids between the fibers of the 3D entanglement of fibers of the first layer 31 of padding are left free. This produces a highly breathable padding, due to the numerous interspaces between the fibers that promote air circulation, and in contrast to a molded polyurethane body, which is similar to a body that is comparatively non-permeable to air.

The padding may be, without limitation, a seat padding, in particular a seat padding, or a backrest padding, an armrest padding, or any other seat padding.

The padding 2 comprises a deep groove 20, on the surface of the padding side intended to receive an occupant, as well as a first housing LG1, and a second housing LG2. The first housing LG1 and the second housing LG2 may be formed by two recesses opening from a surface of the padding opposite the surface of the padding bearing the groove 20, and, for example, a lower surface of the padding.

The first housing LG1 and the second housing LG2 are respectively in communication with the groove 20 directly, or indirectly by a first hole T1 in the bottom of the groove 20, connecting the first housing LG1 to the groove, and by a second hole T2 in the bottom of the groove connecting the second housing LG2 to the groove 20. The first housing LG1 may be in communication with the first hole T1 by a first lateral passage Pas1, and the second housing LG2 may be in communication with the second hole T2 by a second lateral passage Pas2, and as illustrated by way of non-limiting example in FIG. 6.

Generally speaking, and as can be understood in FIG. 6, the groove 20 may be located on a surface of the padding, and the first hole T1 and the second hole T1 may extend beyond the depth of the groove 20. The first hole T1 and the second hole T2 are preferably blind, i.e. not through, extending only over a portion of the padding along the direction of the groove height 20. Generally, the fastening device 3 is fixed in the padding, being positioned on an upper portion of the padding layer, a lower portion of the padding layer being devoid of fastening device 3.

This allows free deformation of the padding when an occupant puts pressure on the padding on the side of the groove 20, the fastening device 3 advantageously accompanying the deformation of the padding by compression of the padding, for example, according to its thickness, and without risk of the rigid fastening device 3 coming into abutment against a hard surface such as a frame part, on the side of the padding opposite it from the groove. Such untimely contact between the fastening device, hard, which would cause the first fixing part 30 to protrude outside the groove 20, being perceived as a hard point by an occupant resting on the padding on this side: this disclosure preferably makes it possible to avoid this drawback.

Preferably, the free section of the fastening device from the mouth of the hole, on the side opposite the groove, may represent at least half the length of the second portion of the hole along the axis A.

The padding system comprises the removable fastening device 3, secured to the padding 2, which is configured to provide the fastening of a cover to the padding.

The fastening device 3 comprises:
a first fastening part 30 configured to allow the fastening of the cover, the fastening part held projecting in the groove 20
a second attachment part 31 comprising a first locking wing 311 and a second locking wing 312, arranged on either side of the first clipping part 30. In particular, the first fastening part 30 may be a clipping part comprising a deformable elastic portion.

The fastening device 3 is configured to be fixed to the padding by:
inserting the fastening device 3 into the padding, in a first insertion position P1 in order to position the first fixing part 30 within the groove 20, and the first locking wing 311 and the second locking wing 312 within the groove, or preferably by insertion into the first hole T1 and the second hole T2 in the depth of a bottom wall of the groove 20
locking the fastening device to the padding by rotating the fastening device 3 about an axis of rotation AR, from the first insertion position P1 to a second locking position P2 so as to cause the first locking wing 311 and the second locking wing 312 to penetrate, respectively, into the first housing LG1 which comprises a stop wall engaging with a terminal end of the first locking wing 311 and into the second housing LG2 which comprises a wall of abutment engagement with a terminal end of the second locking wing 312.

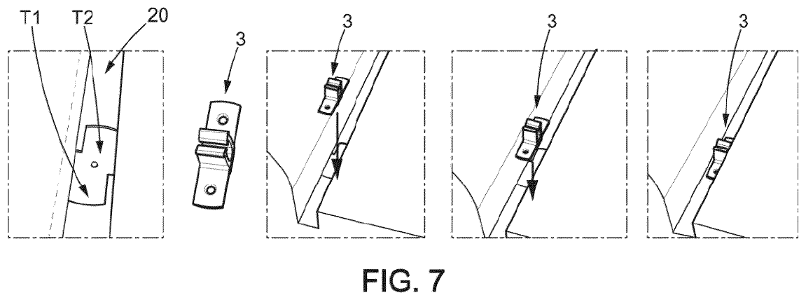

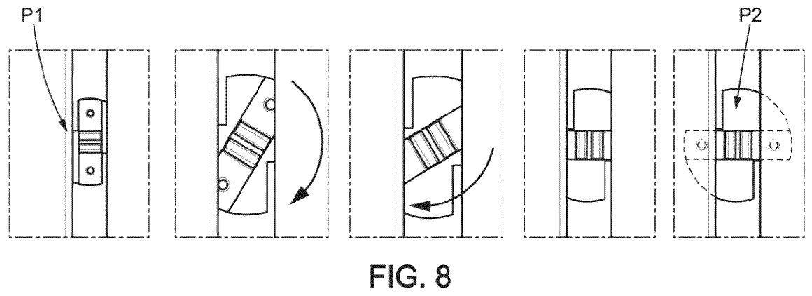

The insertion step is illustrated, according to the first embodiment in FIG. 7, according to the third embodiment in the left view. During this step, the fastening device 3 is oriented so that the direction passing through the terminal ends of the first and second wings 311, 312 is substantially aligned with a longitudinal axis of the groove 20.

During rotation of the fastening device, the first wing and the second wing are rotated about the axis of rotation, and respectively pass through the first passage Pas1 and the second passage Pas2 to be inserted respectively into the first housing LG1 and the second housing LG2.

The axis of rotation AR is thus substantially transverse to the bottom of the groove 20, in particular substantially perpendicular to the bottom.

In the second locking position P2, the engagements between the first locking wing 311 and the second locking wing 312 and the stop walls PB are configured, during a tensile force generated by the cap, to prevent extraction of the fastening device 3. The first locking wing 311 and the second locking wing 312 come to bear, respectively on the two stop walls PB of the first and second housings LG1 and LG2, and according to two supports extending transversely on either side of the groove. The fastening device 3 is thus blocked in the direction of extraction, in the direction of the axis of rotation AR. The fastening device 3 is blocked in the direction opposite to the direction of extraction by contact of a base B of the fastening device with the bottom of the groove, as visible in FIG. 2, or the bottom of the first hole T1 or second hole T2.

Generally speaking, once fixed to the padding, the first fixing part, in particular the clip-on part, is preferably entirely housed in the groove of the padding. This avoids the risk that the fastening device, a more rigid element than the padding, is perceived as a hard point by an occupant when it rests on the padding on the side of the groove 20.

Generally speaking, the fastening device 3, including the first fixing part 30, in particular the clip-on part, and the second attachment part 31, may be a single-piece plastic component, for example, plastic, and for example a component obtained by injection molding.

According to one embodiment, the first locking wing 311 and the second locking wing 312 of the fastening device 30 are symmetrical with respect to the rotation axis AR, the rotation axis AR passing through the first fixing part 30. Preferably, the second housing LG2 is symmetrical with the first housing LG1 with respect to the rotation axis AR, and the second hole T2 is symmetrical with the first hole T1 with respect to the rotation axis AR.

The fastening device 30 (including the first fixing part 30, in particular clipping and the second attachment part 31) may be symmetrical with respect to the rotation axis AR. During the insertion step, the fastening device 3 can be inserted into the groove, in either of the two insertion directions, namely according to:
a first arrangement for which the first locking wing is directed, radially to the axis of rotation, in a first direction of the groove and the second wing directed in a second opposite direction, or
a second arrangement for which the second locking wing is directed radially, in the second direction of the groove, the first locking wing directed in the first direction.

Generally speaking, the fastening device 3 can comprise a projecting PLT stud coaxial with the axis of rotation AR, and the bottom of the groove 20 of the padding comprises a complementary housing GC to the stud. Such an embodiment is illustrated by way of example in the figures, and in particular in the sectional view which illustrates the engagement between the PLT stud and the complementary housing GC.

The engagement between the stud PLT and the complementary housing GC provides centering and guidance of the fastening device 3 relative to the padding 2, during rotation of the fastening device, from the first insertion position P1 to the second locking position P2. The axis of rotation AR, and therefore the complementary housing GC, may be centered on the bottom of the groove 20, midway between two side walls of the groove 20, and as illustrated in FIG. 6.

In one manner, the first fixing part 30, in particular the clipping part, may comprise a first element E1 and a second element E2, extending parallel to each other, the first element and the second projecting element of a base B forming between them a hooking groove, in particular an elastic one, for elastic fitting of a hooking rib of the cap. The attachment groove, in particular elastic, is preferably aligned with a longitudinal axis of the groove 20 of the padding 2 in the second locking position P2.

Generally, the padding system 1 may comprise several fastening devices 3, distributed and fixed to the padding along the length of the groove 20, and thus offering several first fastening parts 30, in particular clipping parts and therefore several elastic attachment grooves, internal to the groove, the first clipping parts spaced apart along the length of the groove. Orienting the elastic groove along the axis of the groove (at least locally) advantageously allows elastic fitting of the same attachment rib in the different attachment grooves.

According to one embodiment, the padding system 1 may comprise a locking system configured to provide locking of the rotation of the attachment device 3 relative to the padding 2 in the second locking position P2. Such a locking system is configured to prevent accidental disassembly of the fastening device 3.

The locking system may comprise at least one orifice of the first locking wing 311 and/or of the second locking wing 312, such as a first orifice O1 of the first locking wing 311 and a second orifice O2 of the second locking wing 312, and at least one protruding lug of the stop wall PB of the first housing LG1 and/or of the second housing LG2, such as a first lug EG1 of the stop wall PB of the first housing LG1 and/or a second lug EG2 of the stop wall of the second housing LG2.

The locking system is configured to provide rotational locking of the fastening device 3 relative to the padding 2, by engaging the lug in the at least one orifice in the second locking position P2, and in particular the first lug LG1 in the first orifice O1, and the second lug LG2 in the second orifice O2.

When rotating from the first insertion position P1 to the second locking position P2, the at least one lug, in particular the first lug EG1 and the second lug EG2 the locking wings 311, 312 cooperate elastically with the lugs EG1, EG2, before the lugs penetrate into the at least one orifice, in particular the first orifice O1 and the second orifice O2 in order to lock the rotation of the fastening device 3.

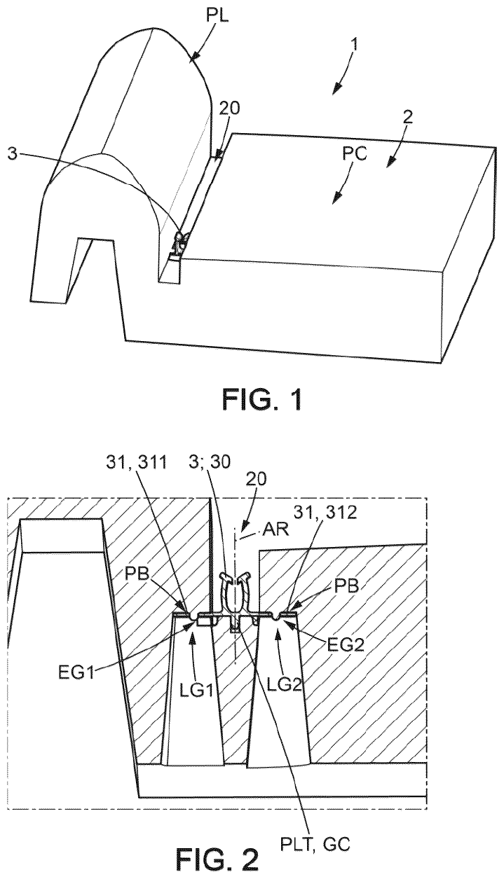

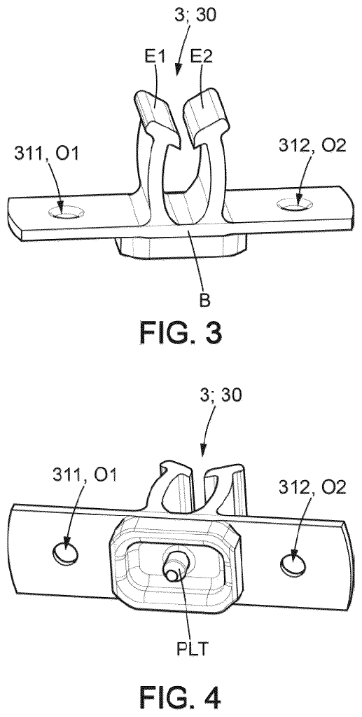

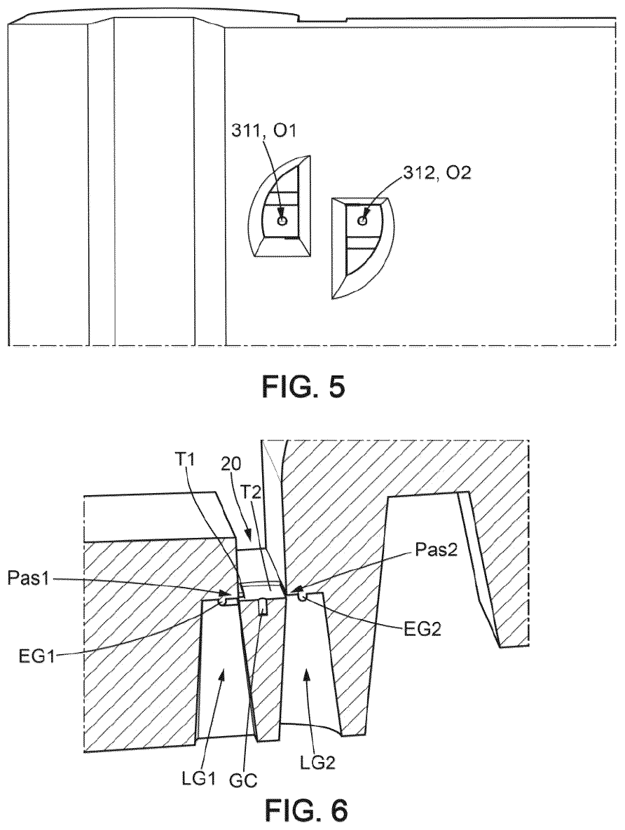

The angular travel a of the fastening device 3 from the first insertion position P1 to the second insertion position P2 may, for example, be between 10° and 90° around the rotation axis AR. The angular travel a may be a quarter turn, or 90° around the rotation axis AR, and for example illustrated according to a first embodiment in FIGS. 1 to 8.

According to such an embodiment, the first locking wing 311 and the second locking wing 312 extend in a longitudinal direction in a plane of the base B of the first fixing part, in particular from the two terminal ends of the first locking wing 311 and the second locking wing 312, and for example in a direction orthogonal to the direction of the attachment groove. Such an orientation of the attachment groove relative to the locking wings 311, 312 allows the attachment groove of the first fixing part 30 to be aligned with the groove, in the second locking position P2, after rotation of a quarter turn.

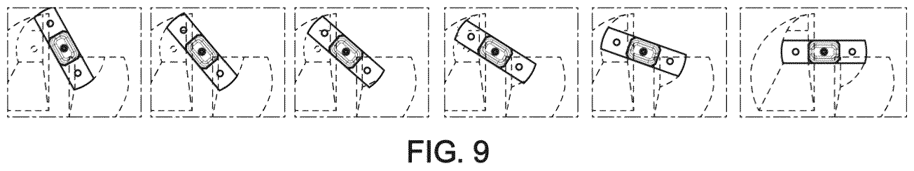

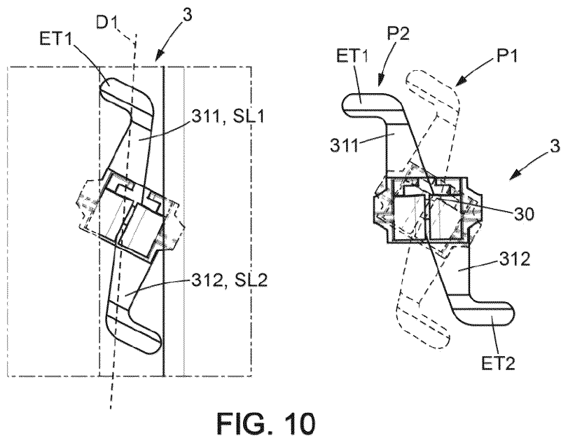

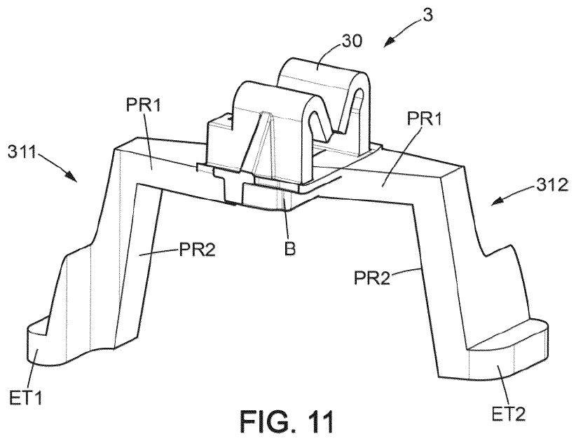

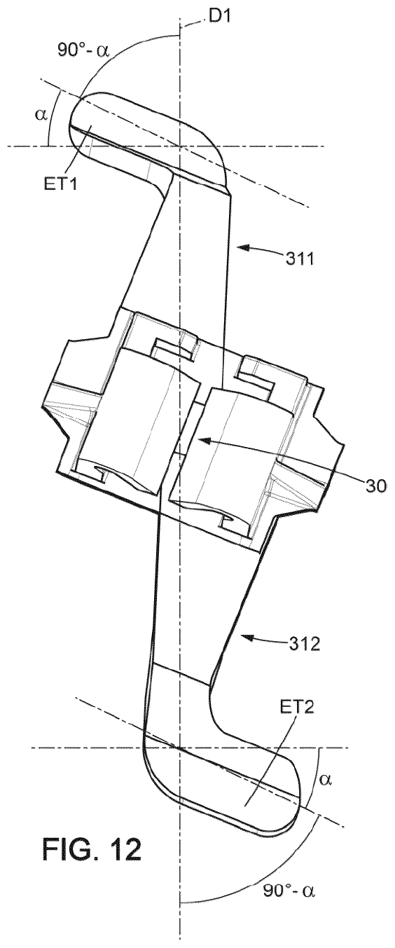

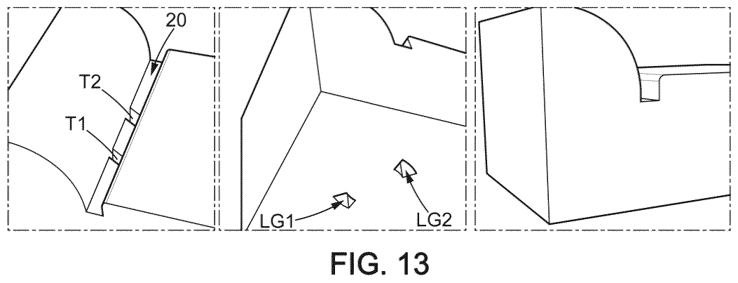

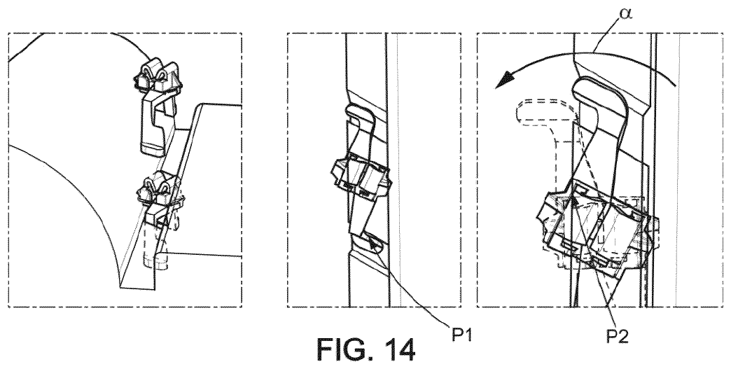

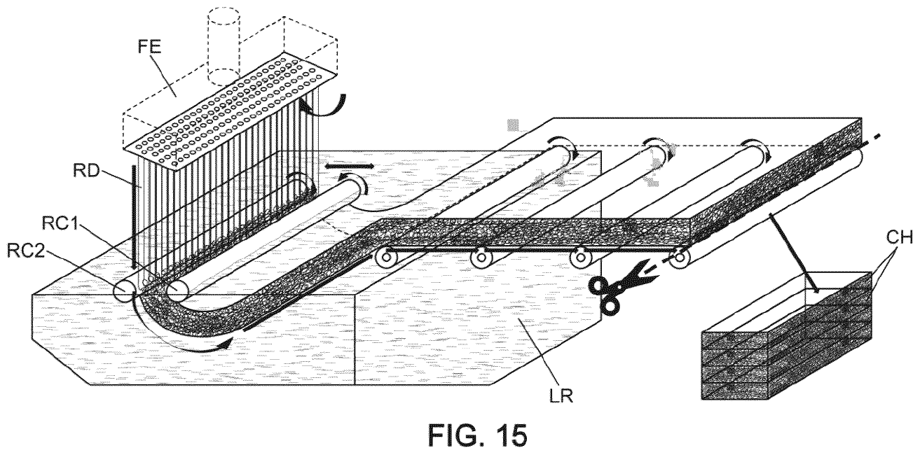

According to other embodiments of the fastening device 3, for example illustrated in FIGS. 9 to 14, the geometry of the first locking wing 311 and the second locking 312 may be configured to provide an angular travel a between the first insertion position P1 and the second locking position P2 around the rotation axis AR, limited, much less than 90°, and in particular less than 45°, or even less than 30°

To this end, as illustrated according to the embodiment of FIG. 10, or that of FIG. 12, the first wing 311 and the second locking wing 312 may comprise:
first sections of length SL1 extending diametrically opposite relative to the base, away from the rotation axis AR, the first sections of length following a first direction D1,
the terminal ends ET, comprising a first terminal end ET1 and a second terminal end ET2 extending inclined relative to the first direction D1, in opposite directions. When the angular travel is of value a. The inclination between the longitudinal direction of the first terminal end ET1 and the direction D1 may, for example, be an angle 90°—α and the inclination between the longitudinal direction of the second terminal end ET2 and the direction D1 may, for example, be an angle 90°—α.

As visible in FIG. 10 or in FIG. 12, the first locking wing and the second locking wing (with their inclined terminal end) form an S shape when seen along the rotation axis AR.

Thus the fastening device is configured to allow rotation from the first insertion position P1 to the second locking position P2 according to an angular travel a less than 45°, for example less than 30°.

In the second locking position P2, as illustrated in particular in the image on the right in FIG. 14, the first terminal end ET1 and the second terminal end ET2 extend in length substantially orthogonal to the direction of the groove, to penetrate the first housing LG1 and the second housing LG2, on either side of the groove 20.

According to an embodiment in FIGS. 1 and 2, or in FIG. 9, the first locking wing 311 and the second locking wing 312 extend in a plane of the base B of the first fixing part 30, and so that the stop walls of the first housing LG1 and of the second housing LG2 are level with the bottom of the groove.

According to another embodiment of FIGS. 11 to 14, the first locking wing 311 and the second locking wing 312 extending in extension of a base B of the first fixing part, may respectively comprise:
first portions of length PR1 extending diametrically opposite relative to the base along a plane of the base B,
second portions of length PR2, in extension of the first portions of length, extending at least along a component along the direction of the axis of rotation AR, moving away from the first fixing part 30 from the first portions of length PR1
the terminal ends ET comprising a first terminal end ET1 and a second terminal end ET2 extending outwards along a second plane, perpendicular to the axis of rotation AR, the second plane spaced from the plane of the base B along the direction of the axis of rotation.

In the first insertion position P1 of the fastening device 3, the first portions of length PR1 belonging to the first locking wing 311 and to the second locking wing 312 are housed in the groove 20, while the second portions of length PR2 belonging respectively to the first locking wing 311 and to the second locking wing 312 are housed in the first hole T1 and in the second hole T2.

The first terminal end ET1, at the distal end of the first portion of length PR1 is thus at the depth of the first hole T1, at a distance from the bottom of the groove and the second terminal end ET2, at the distal end of the second portion of length PR2 is thus at the depth of the second hole T2, at a distance from the bottom of the groove 20.

Such an embodiment allows the terminal ends ET1 and ET2 to engage with stop walls PB of the first housing LG1 and second housing LG2, at a greater depth than the bottom of the groove, for example by a distance in the direction of the axis of rotation of one centimeter, or even more than the bottom of the groove 20. The distance between the plane of the base B and the second plane containing the terminal ends may be greater than the depth dimension of the groove, or even greater than a multiple (2, 3, etc.) of the depth of the groove 20. Such an offset of the terminal ends ET1, ET2 along the second plane by relative to the plane of the base allows the terminal ends ET to bear on a portion of the padding above the abutment walls, of greater thickness compared to the first embodiment, and in particular with a view to increasing the resistance to tearing.

This disclosure also relates to a vehicle seat assembly comprising a padding system 2 according to this disclosure, and a cover covering all or part of the padding, and fixed to the padding by an element, in particular a clip-on element, which is fixed, in particular by elastic interlocking, with the first fixing part, in particular a clip-on part of the fastening device 3 fixed to the padding.

The material of the padding 2 and the material of the fastening device 3 may be the same material, or two different materials but having similar physicochemical properties, in particular the same chemical composition. Advantageously, this makes it possible to recycle the padding and the fastening device simultaneously without separating them.

For example, the material of the padding 2 and the material of the fastening device 3 may be a thermoplastic polymer, in particular a thermoplastic polymer whose repeating unit of the main chain comprises the ester function and possibly the ether function, very particularly a thermoplastic elastomer whose repeating unit of the main chain comprises the ester function and possibly the ether function. Also, this disclosure thus relates to a method for recycling a vehicle seat assembly according to this disclosure, in which the material of the padding 2 and of the fastening device 3 is a thermoplastic polymer as defined above, comprising:
optionally, separation of the cover from the cushioning system,
grinding of the cushioning 2 and the fastening device 3 attached to the cushioning, for the production of granules
use of the granules for the manufacture of a plastic product based on a thermoplastic polymer as defined above, in particular by molding or extrusion.

Optionally, when the cover is also made of a thermoplastic, in a material compatible with that of the cushioning and the fastening device, the cover is not removed and is ground simultaneously with the cushioning and the fastening device, further simplifying recycling.

This disclosure also relates to a method for manufacturing a cushioning system according to this disclosure comprising:
/A/ Obtaining a cushion by extruding a 3D tangle of continuous thermoplastic fibers arranged irregularly forming loops welded together,
   /B/ Shaping the 3D tangle by thermoforming in order to obtain a groove 20 and a first housing LG1 and a second housing LG2 in communication with the groove 20, or even a first hole T1 connecting the groove and the first housing LG1, and a second hole T2 connecting the groove and the second housing LG2
   /C/ Providing a fastening device comprising:
   a first fastening part 30, (in particular a clip-on part comprising in particular a deformable elastic portion) configured to allow the fastening of the cover,
   a second attachment part 31 comprising a first locking wing 311 and a second locking wing 312, arranged on either side of the first fixing part 30,
   /D/ inserting the fastening device 3 into the padding, in a first insertion position P1 in order to position the first fixing part 30 within the groove 20, and the first locking wing 311 and the second locking wing 312 within the groove, or else inserted into a first hole T1 and a second hole T2 in the depth of a bottom wall of the groove 20,
/E/ locking the fastening device to the padding by rotating the fastening device 3 around an axis of rotation AR, from the first insertion position P1 to a second locking position P2 so as to cause the first locking wing 311 and the second locking wing 312, respectively, to penetrate into the first locking housing LG1 which forms a stop wall engaging with the first locking wing 311, and the second housing LG2 forming a abutment wall engaging with the second locking wing 312, the engagements between the first locking wing 311 and the second locking wing 312 and the abutment walls configured, during a tensile force generated by the cap, to prevent extraction of the fastening device 3.

According to one embodiment, in /A/ the 3D entanglement of continuous fibers is obtained according to a method comprising:
/A1/ Extrusion of a thermoplastic polymer in an extrusion die comprising extrusion nozzles distributed along a lengthwise direction and along a widthwise direction of the extrusion die, generating a curtain of molten continuous fibers, falling by gravity,
/A2/ Reception of the curtain of molten continuous fibers falling by

gravity on one or more support elements with generation of a 3D entanglement of fibers arranged irregularly with fusion of loops between the continuous fibers,
/A3/ Solidification of 3D entanglement of fibers by immersion in a cooling liquid.

Reference is now made to FIG. 15, which represents an example of a manufacturing process for the insert. The process comprises an extrusion of a thermoplastic polymer, in particular a thermoplastic polymer as defined above, in an FE extrusion die of the installation. The FE extrusion die may in particular be supplied with granules of thermoplastic polymer, in particular a thermoplastic polymer as defined above, for example from a recycling process.

The FE extrusion die comprises extrusion nozzles, distributed along a lengthwise direction and along a widthwise direction of the extrusion die. In /A1/, the extrusion die, from the thermoplastic polymer, generates a curtain RD of continuous molten fibers, falling by gravity. The curtain of melted continuous RD fibers then passes between two counter-rotating calendering members RC1, RC2, for example in the form of rollers, with generation of a 3D entanglement of fibers according to an irregular or random distribution, with fusion of loops between the continuous fibers and according to a layer of total thickness determined by the center distance between the two calendering members RC1, RC2.

In /A2/, the two calendering members RC1, RC2 are rotated at a speed, for example, lower than the fiber fall speed, providing an accumulation of fibers causing the formation of loops that heat-weld between fibers, generating the irregular, random, three-dimensional entanglement.

Finally, the 3D entanglement of fibers is solidified by immersion in a cooling liquid LR to form a cushion, which, after a possible cutting operation, allows the 3D entanglement of continuous fibers. Solidification is obtained just after step /B2/, the two guide members being able to be immersed halfway into the cooling liquid, for this purpose.

The continuously scrolling 3D fiber entanglement layer is then guided out of the coolant tank to be dried, for example, by shaking/vibrating. The unrolled layer is then cut, by transverse cuts, allowing the production of different first layers CH of padding, and as visible in FIG. 10.

The 3D fiber entanglement layer can be shaped in particular by thermoforming to form the groove 20, or even the first hole T1, and the second T2 from the side of the padding receiving the occupant of the seat, the first hole T1 and the second hole T2 emerging from the bottom of the groove 20. The complementary housing intended to cooperate with the stud PLT can be thermoformed during the formation of the groove 20.

The first housing LG1 and the second housing LG2 can be thermoformed from a second side of the padding opposite that bearing the groove, by non-through recesses emerging from this second side. The first lug EG1 and the second lug EG2 can be thermoformed simultaneously. A first passage Pas1 is created between the first housing LG1 and the first hole T and a second passage Pas2 is created between the second housing LG2 and the second hole T2. The thermoforming of the first housing LG1 and the second housing LG2 makes it possible in particular to densify the 3D entanglement of thermoplastic fibers, and in particular at the level of the stop walls PB intended to retain the first locking wing 311 and the second locking wing 312.

It is understood that the cushioning system may comprise a fastening device 3, or even preferably several fastening devices, and in particular several fastening devices as previously described, distributed along the length of the same groove.

When the padding is a seat padding or a back padding, the padding, in particular the 3D tangle of continuous fibers, may comprise a central portion (for example, called a medallion), intended to receive the buttocks and/or the thighs of the occupant of the seat in the case of a seat padding, and at least one lateral portion PL, in particular a right lateral portion and a left lateral portion, for example, in the form of a lateral sausage, projecting relative to the central portion PC, the lateral portion configured to provide lateral support of the occupant, raised relative to the central portion.

The groove 20 may extend along the length of the padding, over the depth of the central portion PC, along the lateral portion, the groove 20 juxtaposed with the lateral portion, and with a view to stretching the cover over the central portion, but also against the surface of the central portion of the padding.

### LIST OF REFERENCE SYMBOLS

1: Padding system,
2. Padding,
20. Groove,
T1, T2 first hole and second hole,
3. Fastening device,
30. First fastening part, in particular clip-on,
E1, E2. First element and second elastic element forming a hooking groove
31. Second attachment part,
311. First locking wing,
312. Second locking wing,
ET, ET1, ET2. Terminal ends, in particular first terminal end and second terminal end,
O1. First hole,
O2. Second hole,
AR. Axis of rotation,
SL1. First length sections,
D1. First direction,
B. Base,
PLT. Stud (centering and guidance),
GC. Additional housing (stud)
PR1. First length sections (extending in the plane of the base),
PR2. Second length sections;
PC. Central section (padding),
PL. Lateral section (padding).
Step 1, Step 2. First pass and second pass

Comparative seat padding may be made substantially from urethane polymer (or polyurethane, PU) foam, particularly polyurethane foam obtained from polyether/polyol (or PUR) polyols. Such foams can be shaped in molds relatively easily to form different shapes of padding for different vehicle seat elements, such as the seat and backrest, for example.

Comparative fasteners may be inserted into the mold, such as rods, inserts that are overmolded. These comparative fasteners allow, in particular, the attachment of a cover to the padding by clipping onto the insert fasteners.

Comparative polyurethane foam padding is satisfactory, but can retain moisture, particularly in humid conditions. This can cause discomfort for an occupant of a vehicle seat whose element includes such padding.

Furthermore, comparative polyurethane foam is traditionally made by mixing, among other things, polyols with isocyanates. The chemical reaction involved emits CO2 to form a foam, the emitted CO2 contributing to global warming.

Furthermore, polyurethane foam is not recyclable. Therefore, at the end of its life, the seats are dismantled to be sorted in order to separate the different recyclable materials and extract the non-recyclable elements. The recyclable elements are then ground to form a new raw material, while the non-recyclable elements are, for example, landfilled, or burned if possible to generate energy.

However, a comparative padding formed from a 3D tangle of continuous fibers, arranged irregularly to form loops welded together, which is breathable and less expensive in terms of CO2 to manufacture. The comparative fasteners used as inserts in polyurethane foam padding are not compatible with this 3D entanglement of continuous fibers.

The densification and stiffening of local areas of the 3D entanglement to enable the attachment of a cover to the padding, and using various techniques.

According to the findings, there is a need for other fastening systems suitable for attaching a cover to padding, and in particular to padding formed from a 3D entanglement of continuous fibers.

A padding system is proposed, comprising:
padding comprising a groove on a surface of the padding intended to receive an occupant
a removable fastening device, integral with the padding, configured to provide the fastening of a cover to the padding, the fastening device comprising:
a first fastening part, in particular a clip-on part, comprising in particular a deformable elastic portion, configured to allow the fastening of the cover, the first fastening part, held projecting in the groove, comprising a base,
a second attachment part comprising at least a first locking wing and a second locking wing, extending on either side of the base, arranged on either side of the first fastening part,

and in which the fastening device is configured to be fastened to the padding by:
inserting the fastening device into the padding, in a first insertion position in order to position the first fixing part within the groove, and the first locking wing and the second locking wing within the groove, or inserted into a first hole and a second hole deep in a bottom wall of the groove,
locking the fastening device to the padding by rotating the fastening device around an axis of rotation, from the first insertion position to a second locking position so as to cause the first locking wing and the second locking wing to penetrate, respectively, into a first housing forming a stop wall engaging with a terminal end of the first locking wing, and a second housing forming a stop wall engaging with a terminal end of the second locking wing, the engagements between the first locking wing and the second locking wing and the stop walls being configured, during a tensile force generated by the cap, to prevent extraction of the fastening device.

The features set out in the following paragraphs may, optionally, be implemented independently of one another or in combination with one another:

According to one embodiment, the first locking wing and the second locking wing of the fastening device are symmetrical with respect to the axis of rotation, the axis of rotation passing through the first fixing part, or even the fastening device is symmetrical with respect to the axis of rotation.

According to one embodiment, the fastening device comprises a stud projecting below the base, the stud coaxial with the axis of rotation, and the bottom of the groove of the padding comprises a housing complementary to the stud, the engagement between the stud and the complementary housing providing centering and guidance of the fastening device relative to the padding during rotation of the fastening device from the first insertion position to the second locking position.

Generally, the axis of rotation is transverse to the bottom of the groove, for example, perpendicular to the bottom of the groove.

According to one embodiment, the first fixing part is a clipping part comprising a first element and a second element, extending parallel to each other, the first element and the second element projecting from the base forming between them a hooking groove for elastic engagement of a hooking rib of the cover, the hooking groove preferably aligned with a longitudinal axis of the groove of the padding in the second locking position.

According to one embodiment, a locking system is configured to provide locking of the rotation of the fastening device relative to the padding in the second locking position, and comprising at least one orifice of the first locking wing and/or of the second locking wing such as a first orifice of the first wing and a second orifice of the second wing, and at least one protruding lug of the stop wall of the first housing and/or of the second housing, such as a first lug of the stop wall of the first housing and a second lug of the stop wall of the second housing

and in which the locking system is configured to provide locking in rotation of the fastening device relative to the padding by engagement of the lug in the at least one orifice in the second locking position.

According to one embodiment, the first locking wing and the second locking wing extend as an extension of the base of the first fixing part, in particular of the base, the first locking wing and the second wing extending along a plane of the base, perpendicular to the axis of rotation up to the terminal ends of the first locking wing and the second wing, configured to penetrate the first housing and the second housing.

According to one embodiment, the first wing and the second locking wing comprise:
first length sections extending diametrically opposite relative to the base, away from the axis of rotation, the first length sections following a first direction D1,
the terminal ends, comprising a first terminal end and a second terminal end extending inclined, relative to the first direction D1, in opposite directions, in particular the first terminal end and the second end along a plane perpendicular to the axis of rotation

and in which the fastening device is configured to allow rotation from the first insertion position to the second locking position according to an angular travel of less than 45°, for example less than 30°.

According to one embodiment, the first locking wing and the second locking wing extending as an extension of a base of the first fixing part, the first locking wing and the second locking wing respectively comprise:
first length portions extending diametrically opposite relative to the base along a plane of the base,
second length portions, extending as an extension of the first length portions, at least along a component along the direction of the axis of rotation, moving away from the first fixing part from the first length portions
the terminal ends comprising a first terminal end and a second terminal end extending outwardly along a second plane, perpendicular to the axis of rotation, the second plane spaced from the plane of the base along the direction of the axis of rotation.

According to one embodiment, the fastening device, including the first fastening part, in particular the clipping part, and the second attachment part, is a single-piece plastic component.

According to one embodiment, the padding comprises a 3D tangle of continuous thermoplastic fibers arranged irregularly forming loops welded together, the groove, the first housing and the second housing being formed in the 3D tangle of fibers, in particular at the densified zone of the tangle.

According to one embodiment, the material of the padding and the material of the fastening device are a thermoplastic polymer whose main chain repeating unit comprises the ester function and optionally the ether function.

According to one embodiment, in the second locking position, the two abutment walls of the first and second housings, bearing respectively with the first terminal end and the second terminal end, are two supports extending transversely on either side of the groove.

According to one embodiment, the first housing and the second housing are formed by two recesses opening from a surface of the padding opposite the surface of the padding carrying the groove, the first housing and the second housing being respectively in communication with the groove directly according to a first possibility, or indirectly according to a second possibility by a first hole in the bottom of the groove, connecting the first housing to the groove, and by a second hole in the bottom of the groove connecting the second housing to the groove, the first housing in communication with the first hole by a first lateral passage, and the second housing in communication with the second hole by a second lateral passage.

The fastening device is oriented so that the direction passing through the terminal ends of the first and second wings is substantially aligned with a longitudinal axis of the groove in the first insertion position.

The locking of the fastening device to the padding is obtained by rotation of the fastening device about the transverse rotation axis at the bottom of the groove, from the first insertion position to a second locking position, rotation during which the first locking wing and the second locking wing respectively pass through the first passage and the second lateral passage, to be inserted respectively into the first housing and the second housing according to the second possibility.

According to an embodiment in the second locking position, the fastening device is locked in the direction opposite to the extraction direction by contact of the base of the fastening device with the bottom of the groove or the bottom of the first hole or second hole.

This disclosure also relates to a vehicle seat assembly comprising a padding system according to this disclosure, in the locking position of the fastening device and a cover covering all or part of the padding, and fixed to the padding by a fixing element, in particular a clip-on element, engaging, for example in an elastic interlocking manner with the first fixing part, of the fastening device.

This disclosure also relates to a method for manufacturing a cushioning system according to this disclosure comprising:
/A/ Obtaining a cushioning by extruding a 3D tangle of continuous thermoplastic fibers, arranged irregularly, forming loops welded together,
/B/ Shaping the 3D tangle by thermoforming in order to obtain the groove and a first housing and a second housing in communication with the groove
/C/ Providing a fastening device comprising:
a first fastening part, in particular a clip-on part, comprising in particular a deformable elastic portion, configured to allow the fastening of the cap,
a second fastening part comprising a first locking wing and a second locking wing, arranged on either side of the first fastening part,
/D/ inserting the fastening device into the cushioning, in a first insertion position in order to position the first fastening part within the groove, and the first locking wing and the second locking wing within the groove, or inserted into a first hole and a second hole deep in a groove bottom wall,
/E/ locking the fastening device to the padding by rotating the fastening device around an axis of rotation from the first insertion position to a second locking position so as to cause the first locking wing and the second locking wing to penetrate, respectively, into the first locking housing which forms a stop wall engaging with the first locking wing, and the second housing forming a stop wall engaging with the second locking wing, the engagements between the first locking wing and the second locking wing and the stop walls being configured, during a tensile force generated by the cap, to prevent extraction of the fastening device.

This disclosure also relates to a method for recycling a vehicle seat assembly according to this disclosure, in which the material of the padding and the fastening device is a thermoplastic polymer whose main chain repeating unit comprises the ester function and optionally the ether function, comprising:
optionally, a separation of the cover from the padding system,
grinding of the padding and the fastening device attached to the padding, with a view to producing granules
using the granules for the manufacture of a plastic product based on a thermoplastic polymer whose main chain repeating unit comprises the ester function and optionally the ether function, in particular by molding or extrusion.

This disclosure relates to a padding system (1) comprising:
a padding (2) comprising a groove (20) on a surface of the padding intended to receive an occupant, a hole (21) extending in depth of a bottom wall of the groove,
a removable fastening device, integral with the padding (2), configured to provide the fastening of a cover to the padding, the fastening device comprising a first clip-on fastening part (30) and a second attachment part extending into the hole (21) comprising at least one stop wall (PB) configured to come into contact against at least one shoulder (EP) during a tensile force generated by the cover to prevent extraction of the fastening device.

1. A padding system comprising:
a padding comprising a groove on a surface of the padding intended to receive an occupant
a removable fastening device, integral with the padding, configured to provide the fastening of a cover to the padding, the fastening device comprising:
a first fastening part, in particular a clip-on part comprising in particular a deformable elastic portion, configured to allow the fastening of the cover, the first fastening part, held projecting in the groove, comprising a base
a second attachment part comprising at least a first locking wing and a second locking wing extending in extension on either side of the base, arranged on either side of the first fastening part,
and wherein the fastening device is configured to be fastened to the padding by:
insertion of the fastening device in the padding, in a first insertion position in order to position the first fixing part within the groove, and the first locking wing and the second locking wing within the groove, or else in insertion in a first hole and a second hole in the depth of a bottom wall of the groove,
locking the fastening device to the padding by rotation of the fastening device around an axis of rotation, from the first insertion position to a second locking position so as to cause the first locking wing and the second locking wing, respectively, to penetrate into a first housing forming a stop wall engaging with a terminal end of the first locking wing, and a second housing forming a stop wall engaging with a terminal end of the second locking wing, the engagements between the first locking wing and the second locking wing and the stop walls being configured, during a tensile force generated by the cap, to prevent extraction of the fastening device.

2. The padding system of claim 1, wherein the fastening device comprises a projecting stud coaxial with the axis of rotation, and the bottom of the groove of the cushioning comprises a complementary housing to the stud, below the base, the engagement between the stud and the complementary housing providing centering and guiding of the fastening device relative to the cushioning during rotation of the fastening device from the first insertion position (P1) to the second locking position.

3. The padding system of claim 1, wherein the first fixing part is a clipping part comprising a first element and a second element, extending parallel to each other, the first element and the second projecting element of the base forming between them a hooking groove for elastic engagement of a hooking rib of the cover, the hooking groove, aligned with a longitudinal axis of the groove of the padding in the second locking position.

4. The padding system of claim 1, comprising a locking system configured to provide rotational locking of the fastening device relative to the cushioning in the second locking position, and comprising at least one orifice of the first locking wing and/or of the second locking wing such as a first orifice of the first wing and a second orifice of the second wing, and at least one protruding lug of the stop wall of the first housing and/or of the second housing, such as a first lug of the stop wall of the first housing and a second lug of the stop wall of the second housing and wherein the locking system is configured to provide rotational locking of the fastening device relative to the cushioning by an engagement of the lug in the at least one orifice in the second locking position.

5. The padding system of claim 1, wherein the first locking wing and the second locking wing extend in extension of the base of the first fixing part, the first locking wing and the second wing extend along a plane of the base, perpendicular to the axis of rotation up to the terminal ends of the first locking wing and the second wing, configured to penetrate the first housing and the second housing.

6. The padding system of claim 4, wherein in the first wing and the second locking wing extending in extension of the base of the first fixing part, comprise:
first length sections extending diametrically opposite relative to the base, away from the axis of rotation, the first length sections following a first direction,
the terminal ends, comprising a first terminal end and a second terminal end extending inclined relative to the first direction, in opposite directions
and wherein the fastening device is configured to allow rotation from the first insertion position to the second locking position according to an angular travel of less than 45°, for example less than 30°.

7. The padding system of claim 6, wherein the first locking wing and the second locking wing extending in extension of the base of the first fixing part, in particular of the base, the first locking wing and the second locking wing respectively comprise
first length portions extending diametrically opposite relative to the base along a plane of the base,
second length portions, extending in extension of the first length portions, at least along a component along the direction of the axis of rotation, moving away from the first fixing part from the first length portions
the terminal ends comprising a first terminal end and a second terminal end extending outwardly along a second plane, perpendicular to the axis of rotation, the second plane spaced from the plane of the base in the direction of the axis of rotation.

8. The padding system of claim 7, wherein in the second locking position the two stop walls of the first and second housings and, bearing respectively with the first terminal end and the second terminal end are two supports extending transversely on either side of the groove.

9. The padding system of claim 8, wherein the first housing, and the second housing are formed by two recesses opening from a surface of the padding opposite the surface of the padding carrying the groove, the first housing and the second housing being respectively in communication with the groove directly according to a first possibility, or indirectly according to a second possibility by a first hole in the bottom of the groove, connecting the first housing to the groove, and by a second hole in the bottom of the groove connecting the second housing to the groove, the first housing in communication with the first hole by a first lateral passage, and the second housing in communication with the second hole by a second lateral passage,
and wherein the fastening device is oriented so that the direction passing through the terminal ends of the first and second wings is substantially aligned with a longitudinal axis of the groove in the first insertion position,
and wherein the locking of the device for fixing to the padding is obtained by rotation of the fastening device around the axis of rotation transverse to the bottom of the groove, from the first insertion position to a second locking position, rotation during which the first locking wing and the second locking wing respectively pass through the first passage and the second passage, lateral, to be inserted respectively into the first housing and the second housing according to the second possibility.

10. The padding system of claim 9, wherein in the second locking position the fastening device is locked in the direction opposite to the extraction direction by contact of the base of the fastening device with the bottom of the groove or the bottom of the first hole or second hole.

11. The padding system of claim 10, wherein the axis of rotation is transverse to the bottom of the groove, in particular perpendicular to the bottom of the groove.

12. A vehicle seat assembly comprising the padding system according to claim 11, in the second locking position of the fastening device and a cover covering all or part of the padding, and fixed to the padding by a fixing element, in particular a clip element, engaging, for example in an elastic interlocking manner, with the first fixing part of the fastening device.

13. A method for manufacturing the padding system according to claim 11:
/A/ Obtaining a padding by extruding a 3D tangle of continuous thermoplastic fibers arranged irregularly forming loops welded together,
/B/ Shaping the 3D tangle by thermoforming in order to obtain the groove and a first housing and a second housing in communication with the groove
/C/ Providing a fastening device comprising:
a first fastening part, in particular a clip-on part comprising in particular a deformable elastic portion, configured to allow the cover to be fastened,
a second attachment part comprising a first locking wing and a second locking wing, arranged on either side of the first fastening part,
/D/ inserting the fastening device into the padding, in a first insertion position in order to position the first fixing part within the groove, and the first locking wing and the second locking wing within the groove, or else by insertion into a first hole and a second hole in the depth of a bottom wall of the groove,
/E/ locking the fastening device to the padding by rotating the fastening device around an axis of rotation, from the first insertion position to a second locking position so as to cause the first locking wing and the second locking wing, respectively, to penetrate into the first locking housing which forms a stop wall engaging with the first locking wing, and the second housing which forms a stop wall engagement with the second locking wing, the engagements between the first locking wing and the second locking wing and the stop walls being configured, during a tensile force generated by the cap, to prevent extraction of the fastening device.

14. A method of recycling the vehicle seat assembly according to claim 12, wherein the material of the padding and the fastening device is a thermoplastic polymer whose main chain repeating unit comprises the ester function and optionally the ether function, comprising:
optionally, separating the cover from the padding system,
grinding the padding and the fastening device attached to the padding, for the production of granules
using the granules for the manufacture of a plastic product based on a thermoplastic polymer whose main chain repeating unit comprises the ester function and optionally the ether function, in particular by molding or extrusion.
